(19) United States
(12) Patent Application Publication
(10) Pub. No.: US 2025/0247826 A1
(43) Pub. Date: Jul. 31, 2025

(54) SIDELINK UNLICENSED (SL-U) RESOURCE SELECTION FOR LISTEN-BEFORE-TALK (LBT) PROCEDURE

(71) Applicant: QUALCOMM Incorporated, San Diego, CA (US)

(72) Inventors: Chih-Hao LIU, San Diego, CA (US); Yisheng XUE, San Diego, CA (US); Jing SUN, San Diego, CA (US); Sherif ELAZZOUNI, San Diego, CA (US); Siyi CHEN, Beijing (CN); Giovanni CHISCI, San Diego, CA (US); Ozcan OZTURK, San Diego, CA (US); Xiaoxia ZHANG, San Diego, CA (US)

(21) Appl. No.: 18/854,034

(22) PCT Filed: May 9, 2022
(86) PCT No.: PCT/CN2022/091627

§ 371 Date: Oct. 3, 2024

(51) Int. Cl. H04W 72/02; H04W 72/25; H04W 74/0833

(52) U.S. Cl. CPC H04W 72/02; H04W 72/25; H04W 74/085

(57) ABSTRACT

Certain aspects of the present disclosure provide a method for wireless communications by a transmitter user equipment (UE). The method may include selecting a first number of resources for an initial transmission based on a second number of transport blocks (TBs) for the initial transmission where the first number is greater than the second number, and transmitting the initial transmission on one or more of the first number of resources.

### BACKGROUND

### Field of the Disclosure

Aspects of the present disclosure relate to wireless communications, and more particularly, to techniques for resource selection for multiple listen-before-talk (LBT) opportunities in sidelink unlicensed (SL-U) operations.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a transmitter user equipment (UE), comprising: selecting a first number of resources for an initial transmission based on a second number of transport blocks (TBs) for the initial transmission, the first number is greater than the second number; and transmitting the initial transmission on one or more of the first number of resources.

Another aspect provides a method for wireless communications by a receiver UE, comprising: receiving an initial transmission on one or more of a first number of resources, wherein the first number of resources are selected for the initial transmission based on a second number of TBs for the initial transmission, and wherein the first number is greater than the second number; and processing the initial transmission.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIGS. 5A-5B depict diagrammatic representations of example vehicle-to-everything (V2X) systems.

FIG. 6 depicts example autonomous sensing to identify a set of candidate resources in new radio (NR) sidelink.

FIG. 7 depicts example out of channel occupancy time (COT) resource reservation.

FIG. 8 depicts example COT resource reservation via a sidelink control information (SCI).

FIG. 9 depicts example contention slot to start a transmission burst.

FIG. 10 depicts example different channel access priority class (CAPC) values used for determining different starting points of transmissions.

FIG. 11 depicts example termination of a COT.

FIG. 12 depicts a call flow diagram illustrating example communication between a transmitter UE and a receiver UE.

FIG. 13 depicts example evaluation for multiple selected resources when a reservation of the multiple selected resources has a lower priority than a COT transmission.

FIG. 14 depicts example resource selection window.

FIG. 15 depicts example clearance of a listen-before-talk (LBT) procedure.

FIG. 16 depicts example evaluation for a possible resource collision.

FIG. 17 depicts example evaluation before a first selected resource after a projected LBT to check for a possible resource collision.

FIG. 18 depicts a method for wireless communications by a transmitter UE.

FIG. 19 depicts a method for wireless communications by a receiver UE.

FIG. 20 depicts aspects of an example communications device.

FIG. 21 depicts aspects of an example communications device.

### DETAILED DESCRIPTION

Aspects of the present disclosure provide apparatuses, methods, processing systems, and computer-readable mediums for determining resources for sidelink communication. In sidelink, user equipments (UEs) are able to communicate without relaying their data via a network entity such as a base station (BS). Sidelink communication can be communicated over a physical sidelink control channel (PSCCH) and a physical sidelink shared channel (PSSCH).

The deployment of new radio (NR) over an unlicensed spectrum is referred to as NR-unlicensed (NR-U). Some studies have been conducted for NR-U deployment over 5 gigahertz (GHz) unlicensed bands. Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as wireless local area network (WLAN) or WiFi and/or license assisted access (LAA). Sidelink can benefit from utilizing the additional bandwidth available in unlicensed spectrum.

NR sidelink has been used for vehicle-to-everything (V2X) communications over licensed bands. Recently, 3rd generation partnership project (3GPP) has supported the sidelink for other applications (other than the V2X). So far, efforts to use the sidelink for the other applications have been limited to the licensed bands, yet not every other application can access the licensed bands. The present application describes techniques for UEs to perform sidelink communications (e.g., in an unlicensed spectrum).

The deployment of sidelink over an unlicensed spectrum is referred to as sidelink unlicensed (SL-U). To avoid collisions in SL-U operations where all UEs contend for resources, the UEs may employ a listen-before-talk (LBT) procedure to monitor for transmission opportunities. The LBT makes it possible for the UEs to share a same channel. When LBT is enabled, a UE continuously monitors channels so as to transmit only when a channel is not in use. For example, the UE may perform the LBT prior to transmitting in the channel. When the LBT passes, the UE may proceed with the transmission. When the LBT fails, the UE may refrain from transmitting in the channel. The techniques described herein specify how to carry out a resource reservation for an initial transmission to allow more opportunities for the LBT.

In SL-U operations, a conventional resource selection method to select a limited number of resources (e.g., for initial and later transmissions) cannot deal with an LBT failure. This is because when there is the LBT failure, additional resources may be needed (e.g., to clear additional LBT procedures and for the initial transmission). In such cases, the LBT failure may trigger a medium access layer (MAC) layer based resource reselection for the additional resources. However, since the MAC layer based resource reselection has a long delay, the additional resources may not be available when needed. In such circumstances, if a transmitter UE determines to use a future resource (e.g., a resource reserved for a retransmission) for the initial transmission, the future reserved resource may also not be available (e.g., since the future reserved resource may be located far out).

The techniques described herein provide improved resource selection for an initial transmission in SL-U operations, by selecting more resources than a number of transport blocks (TBs) for the initial transmission. The improved resource selection allows multiple LBT opportunities to a transmitter UE. The selected resources may be contiguous in time, and multiple TBs for the initial transmission can be transmitted in one channel occupancy time (COT). The techniques described herein may result in a lower latency, since the improved resource selection for the initial transmission in the SL-U operations minimizes transmission delay due to an LBT failure.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

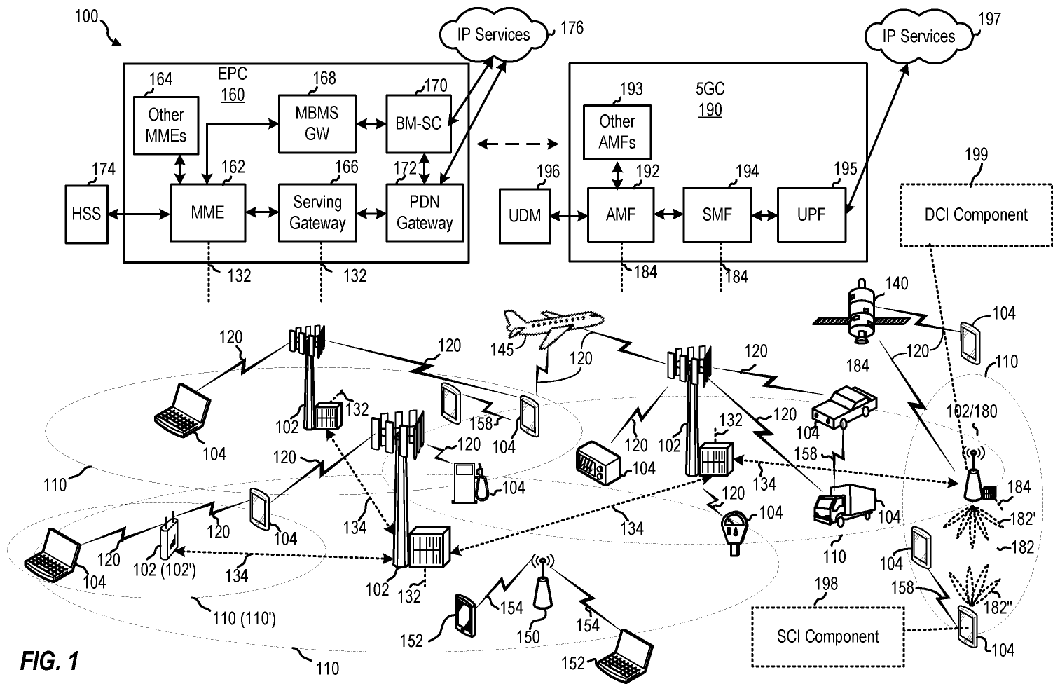

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

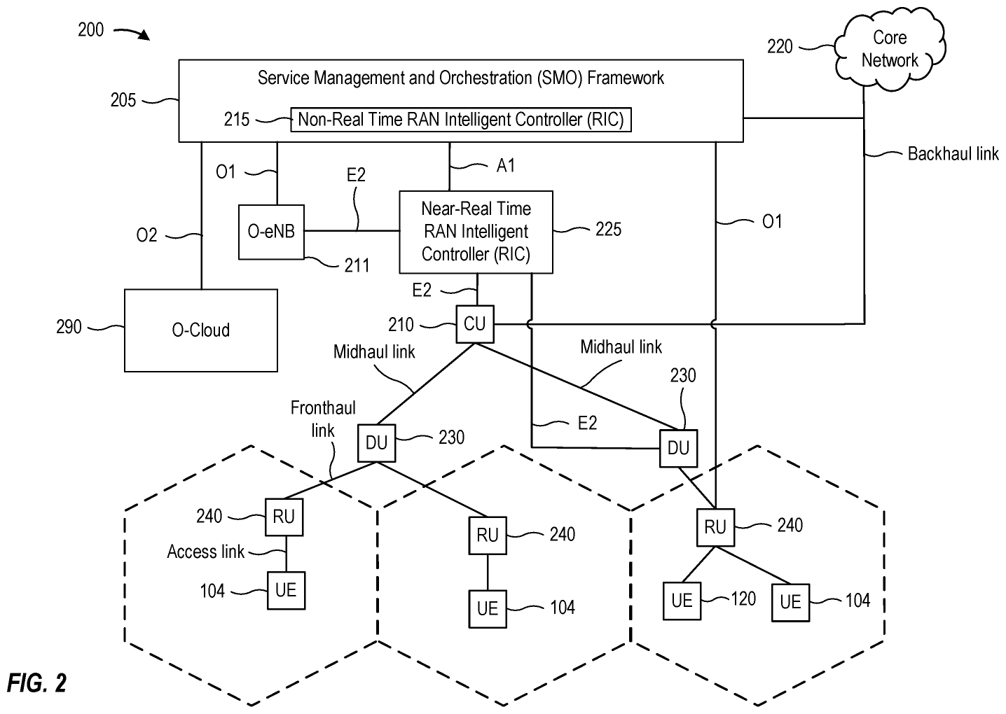

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

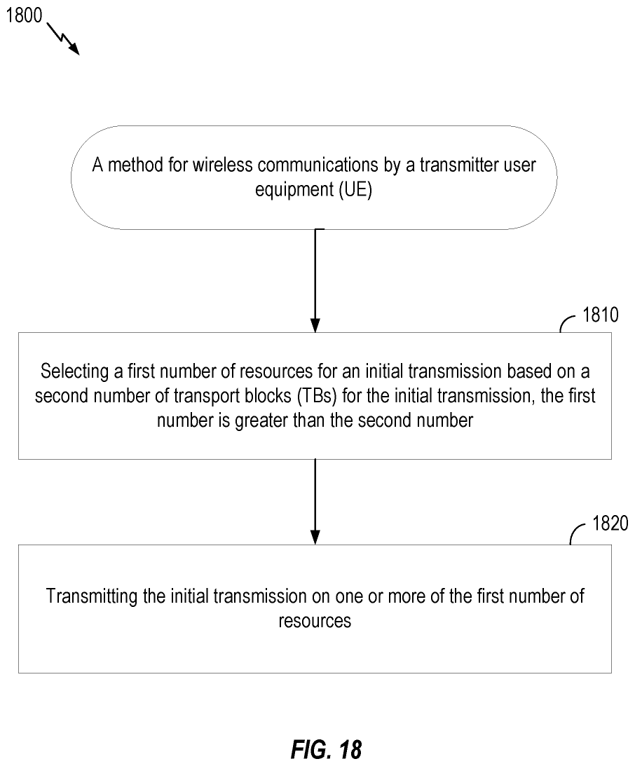

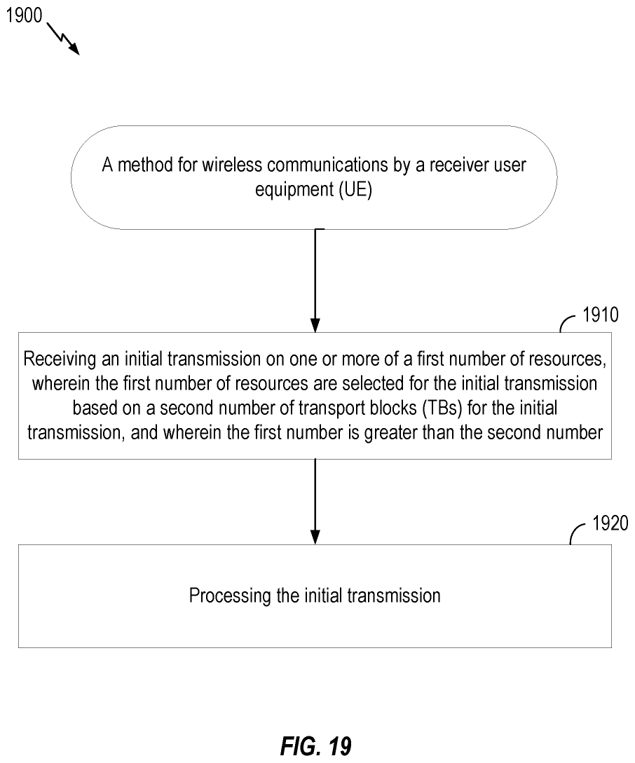

Wireless communication network 100 further includes sidelink control information (SCI) component 198, which may be configured to perform operations 1800 of FIG. 18 and/or operations 1900 of FIG. 19. Wireless communication network 100 further includes downlink control information (DCI) component 199.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

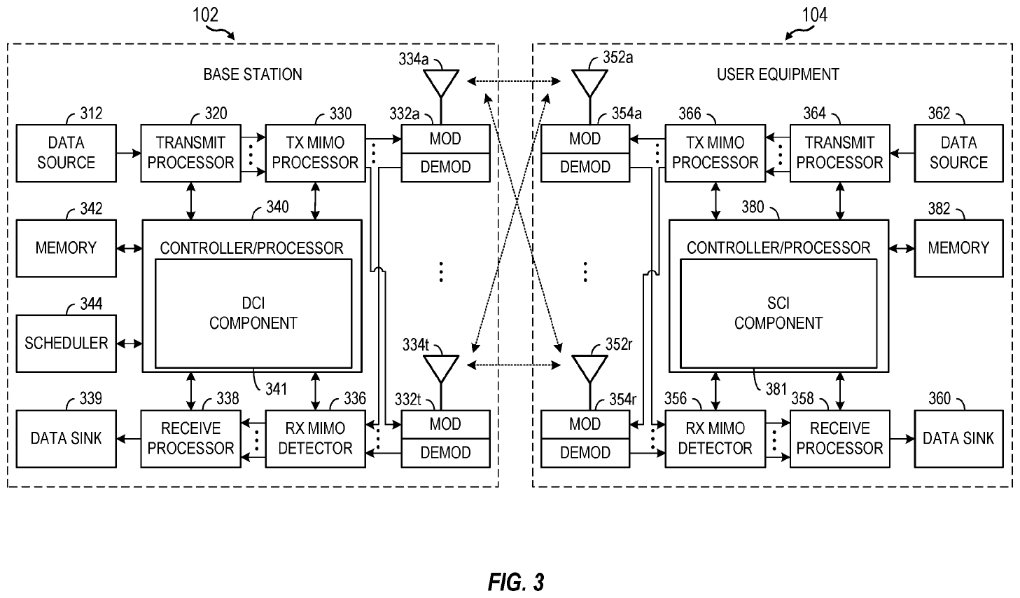

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes DCI component 341, which may be representative of DCI component 199 of FIG. 1. Notably, while depicted as an aspect of controller/processor 340, DCI component 241 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SCI component 381, which may be representative of SCI component 198 of FIG. 1. Notably, while depicted as an aspect of controller/processor 380, SCI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

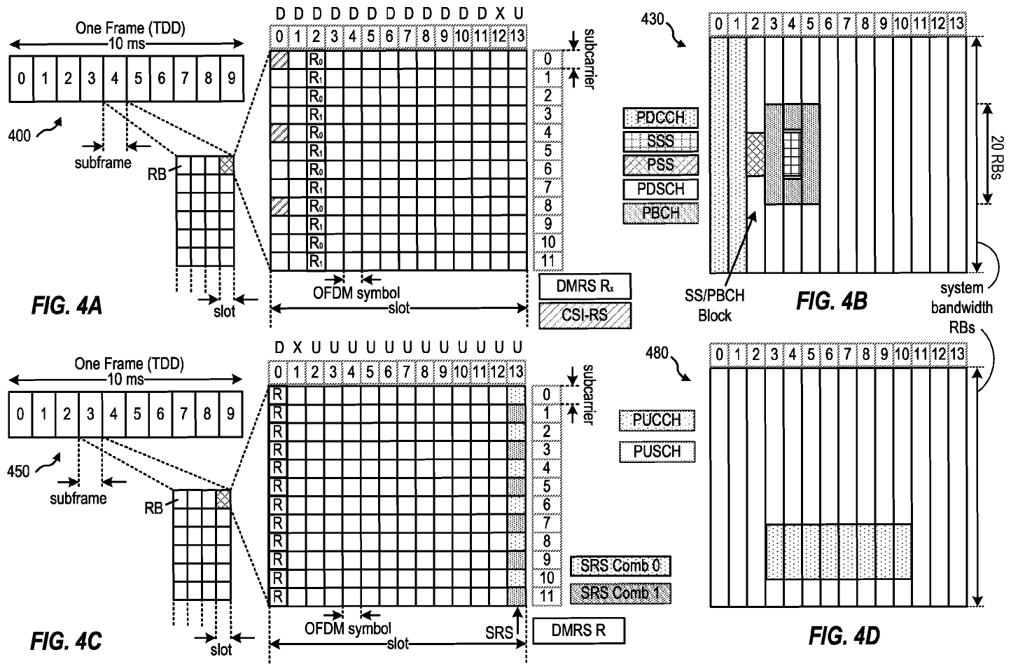

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communication

User equipments (UEs) communicate with each other using sidelink signals. Real-world applications of sidelink communications may include UE-to-network relaying, vehicle-to-vehicle (V2V) communications, vehicle-to-everything (V2X) communications, Internet of Everything (IoE) communications, IoT communications, mission-critical mesh, and/or various other suitable applications.

A sidelink signal refers to a signal communicated from one UE to another UE without relaying that communication through a scheduling entity (e.g., UE or a network entity), even though the scheduling entity may be utilized for scheduling and/or control purposes. In some examples, the sidelink signal is communicated using a licensed spectrum (e.g., unlike wireless local area networks, which typically use an unlicensed spectrum). One example of sidelink communication is PC5, for example, as used in V2V, long term evolution (LTE), and/or new radio (NR).

Various sidelink channels are used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH carries discovery expressions that enable proximal UEs to discover each other. The PSCCH carries control signaling such as sidelink resource configurations, resource reservations, and other parameters used for data transmissions. The PSSCH carries data transmissions. The PSFCH carries a feedback such as acknowledgement (ACK) and/or negative ACK (NACK) information corresponding to transmissions on the PSSCH.

In some NR systems, a two stage sidelink control information (SCI) is supported. The two stage SCI includes a first stage SCI (e.g., SCI-1) and a second stage SCI (e.g., SCI-2). The SCI-1 includes resource reservation and allocation information. The SCI-2 includes information that can be used to decode data and to determine whether a UE is an intended recipient of a transmission. The SCI-1 and/or the SCI-2 may be transmitted over a PSCCH.

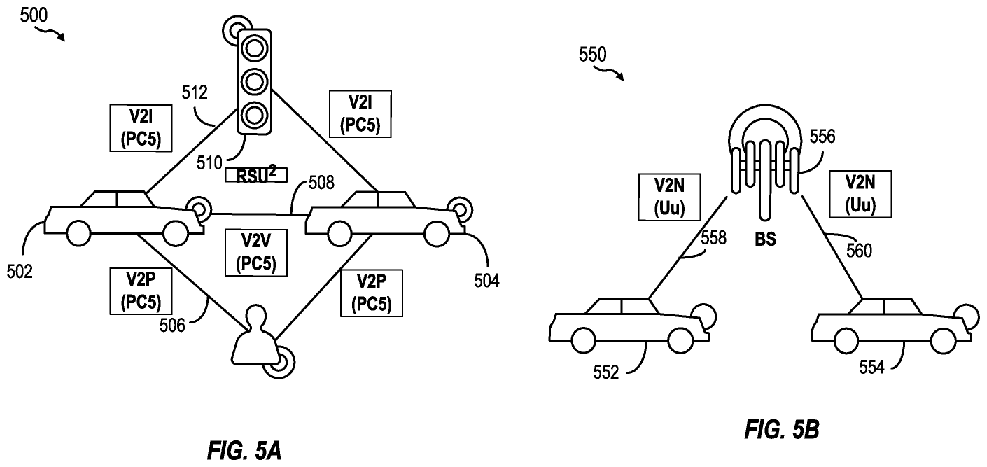

FIG. 5A and FIG. 5B show diagrammatic representations of example V2X systems. For example, vehicles shown in FIG. 5A and FIG. 5B communicate via sidelink channels and relay sidelink transmissions. V2X is a vehicular technology system that enables vehicles to communicate with traffic and an environment around them using short-range wireless signals, known as sidelink signals.

The V2X systems shown in FIG. 5A and FIG. 5B provide two complementary transmission modes. A first transmission mode, shown by way of example in FIG. 5A, involves direct communications (e.g., also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (e.g., including V2V communications) is illustrated with two vehicles 502, 504. A first transmission mode allows for direct communication between different participants in a given geographic location. As illustrated, a vehicle 502 can have a wireless communication link 506 with an individual through a PC5 interface. Communications between the vehicles 502 and 504 may also occur through a PC5 interface 508. In a like manner, communication may occur from the vehicle 502 to other highway components (e.g., a roadside unit (RSU) 510), such as a traffic signal or sign through a PC5 interface 512. With respect to each communication link illustrated in FIG. 5A, two-way communication may take place between devices, therefore each device may be a transmitter and a receiver of information. The V2X system 500 is a self-managed system implemented without assistance from a network entity. A self-managed system may enable improved spectral efficiency, reduced cost, and increased reliability as network service interruptions do not occur during handover operations for moving vehicles. The V2X system 500 is configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. Network communications may occur through discrete nodes, such as a network entity 556 that sends and receives information to and from (e.g., relays information between) the vehicles 552, 554. The network communications through vehicle to network (V2N) links 558 and 560 may be used, for example, for long-range communications between the vehicles 552, 554, such as for communicating the presence of a car accident a distance ahead along a road or highway. Other types of communications may be sent by a wireless node to the vehicles 552, 554, such as traffic flow conditions, road hazard warnings, environmental/weather reports, and service station availability, among other examples. Such data can be obtained from cloud-based sharing services.

### Example Autonomous Sensing in New Radio (NR) Sidelink

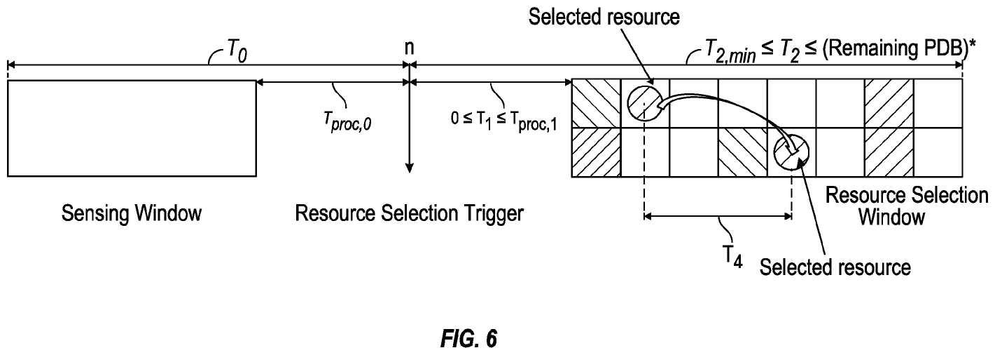

In new radio (NR) Rel′ 16, when a resource selection is triggered (e.g., at time n) as illustrated in FIG. 6, a physical (PHY) layer of a sidelink (or a transmitter) user equipment (UE) examines a sensing window to identify a set of candidate resources in a resource selection window. After identifying the set of candidate resources, the PHY layer reports the set of candidate resources to a medium access control (MAC) layer of the UE. The MAC layer then randomly selects one resource from the set of candidate resources reported by the PHY layer for a transmission.

In some cases (e.g., where there is a reservation for a hybrid automatic repeat request (HARQ) re-transmission), the MAC layer randomly select resources (e.g., from the set of candidate resources) for multiple physical sidelink shared channels (PSSCHs) for a same transport block (TB). For example, as illustrated in FIG. 6, the MAC layer selects two resources for an initial transmission (e.g., r₁) and retransmission (e.g., r₂) that are separated by T₄.

### Example Channel Occupancy Time (COT) Resource Reservation

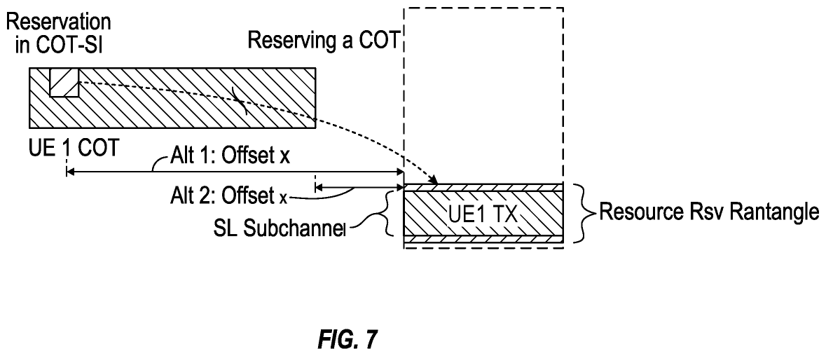

In sidelink unlicensed (SL-U) operation, a reserved resource in future slots is subject to a listen-before-talk (LBT) procedure. In Rel′16, upto two single resource reservations in upcoming 32 slots may not be suitable for the SL-U. In such cases, two distributed reserved resources may require two LBT's and the LBT (e.g., a category 4 (CAT 4) LBT) may not clear right before a reserved slot. Accordingly, as illustrated in FIG. 7, a SL-U user equipment (UE) implements resource reservation in a granularity of a channel occupancy time (COT).

In some cases, a UE may implemet a COT based reservation to silent other SL-U UEs while the UE is performing an LBT in a future reserved COT. The UE may directly reserve a COT (e.g., via a new codepoint in a sidelink control information (SCI)), and then perform a continuous transmission (e.g., a retransmission) in the COT. In one example, a time domain reservation may include a starting time (e.g., a slot) and a duration of the reservation. In another example, a frequency domain reservation may include a starting subband and a number of contiguous subbands, or resource block (RB)-set bitmap indicating reserved 20 MHz subbands.

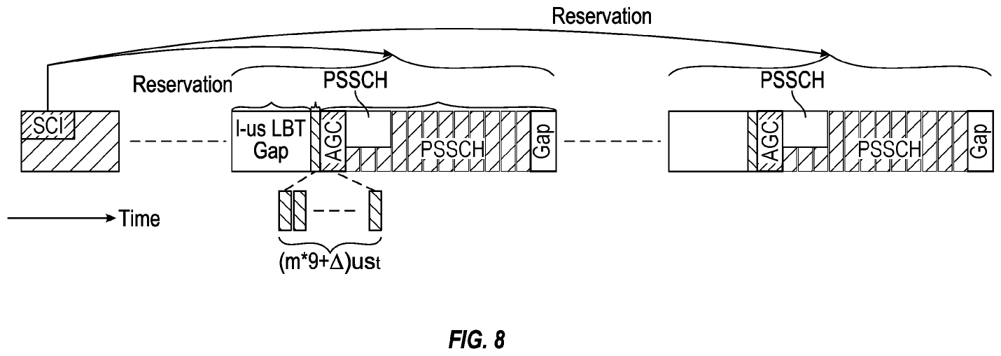

In some cases, a UE reserves a starting slot or starting positions with a cyclic prefix (CP) extension (CPE). For example, as illustrated in FIG. 8, the UE (e.g., when reserving a subchannel while operating over an unlicensed band) may include a new codepoint in a SCI indicating that a sidelink transmission will start with a CPE (e.g., ahead of a slot boundary) and a gap (e.g., l-us for enhanced channel clearance assessment (eCCA)/LBT) before the CPE. Upon receiving the SCI, a sensing/reevaluation UE (e.g., having transport blocks (TBs) of a lower priority) accepts the reservation in the SCI by only occupying a same RB set with a shorter (or none) CPE ahead of the slot boundary and puncturing a physical sidelink shared channel (PSSCH) in a previous slot to keep silence in the gap for the LBT.

In some cases, the UE determines a duration of the CPE (e.g., based on a subcarrier spacing (SCS) and/or a timing advance (TA) value for the transmitter UE). For example, as further illustrated in FIG. 8, the CPE can be (m*9+Δ) us, where 9 μs is a clear channel assessment (CCA) slot with 20 MHz LBT, 0≤Δ (e.g., TA value)<9, and integer m≥0.

### Example Contention Slots

In sidelink unlicensed (SL-U) operation, multiple sidelink user equipments (UEs) may contend for a channel access at a same time. In such cases, when intended transmissions by the multiple UEs start at the same time, there can be collisions. For example, the multiple UEs may determine an empty channel before a slot boundary and then start their transmissions at the same time at the slot boundary. Accordingly, the multiple UEs may interfere with each other. Such interference may apply to both type-1 and type-2 listen-before-talk (LBT) procedure performed by the multiple UEs.

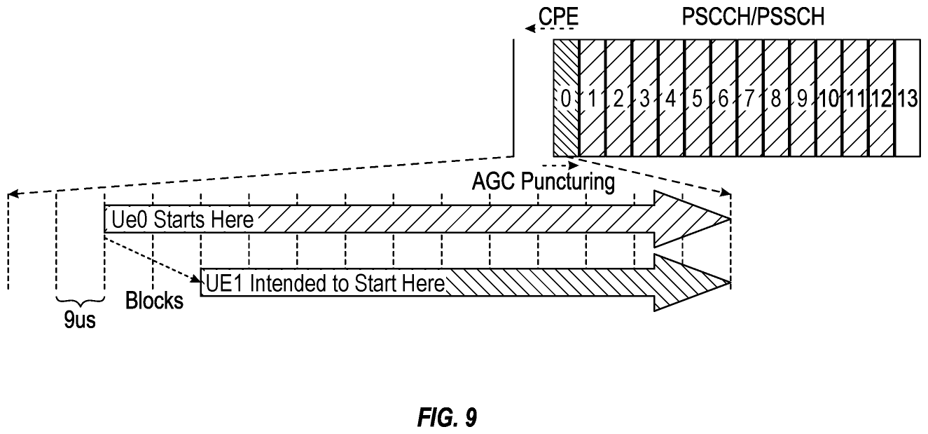

In some cases, instead of starting a transmission burst at a same time by multiple UEs, a new radio (NR) unlicensed (NR-U) configured grant (CG) physical uplink shared chanel (PUSCH) is leveraged to introduce contention slots before the intended transmission. For example, as illustrated in FIG. 9, multiple contention slots (e.g., of 9 μs each) are provided before a slot boundary with a cyclic prefix (CP) extension (CPE) and after the slot boundary with an automatic gain control (AGC) puncturing. Each UE may hash to one of many starting points. In such cases, the UE hashed to an earlier starting point is allowed to start a transmission earlier to stop another UE hashed to a later starting point. In some cases, the contention slots may at least cover one 15 KHz symbol.

In some cases, there is an advantage for a UE to select an earlier starting point from a set of starting points for its transmission. The UE may select the starting point based on multiple rules. The multiple rules may ensure fair access of the UE to a channel, but also consider a priority of transmissions. The multiple rules may include a first rule, a second rule, a third rule, and a fourth rule.

The first rule indicates to randomize a starting point from a set of starting points. For example, the starting point may not need to be fixed, and some randomness in selection of the starting point by UEs can improve fairness.

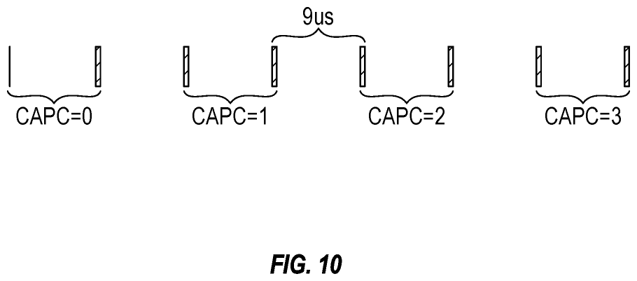

The second rule indicates association of different sets of starting points with different channel access priority class (CAPC) values (e.g., as illustrated in FIG. 10). For example, a UE with a high priority traffic may have a higher chance to access an earlier starting point based on the second rule.

The third rule indicates to allow a UE to statistically access earlier starting points when the UE fails LBT procedure frequently. For example, the UE may be allowed to be more aggressive to access an earlier starting point, if the UE keeps failing the LBT procedure. The UE can also be allowed to use a large extension to compete with WiFi when there are no other UEs that are competing for the LBT.

The fourth rule indicates that for a physical sidelink control channel (PSCCH) and/or a physical sidelink shared channel (PSSCH) carrying a synchronization signal block (SSB) transmission, a higher priority can be used and hashed to an earlier starting point.

Conventional resource selection methods noted above only specify a procedure to reserve overbooking resources in future second and third channel occupancy time (COT) bursts (e.g., for retransmissions or new transport blocks (TBs)) via a sidelink control information (SCI) to address an LBT procedure uncertainty. Furthermore, during a resource selection based on the conventional resource selection methods, a sidelink UE can only randomly select one resource per TB for an initial transmission, and a second or a third retransmission.

Thus, there is a need for techniques for improved resource selection (e.g., to address an LBT procedure uncertainty) that may specify how to select overbooked COT resources for a first transmission burst (e.g., before a reserving SCI is transmitted). This is because, without the improved resource selection, after an LBT failure, a physical (PHY) layer of the UE may communicate with a medium access control (MAC) layer of the UE for resource re-selection or directly go to a future reserved COT resource. However, in such cases, the reserving SCI cannot be sent and the future reserved COT resources may not be available as these resources may be located far out.

The techniques described herein select more sidelink resources to provide additional transmission opportunities in a first transmission burst. In one example case (e.g., for enhanced mobile broadband (eMBB) traffic), a sidelink UE may have multiple TBs to transmit and may select multiple contiguous resources to transmit the multiple TBs within a same COT. There may be less than a predefined timeperiod (e.g., 16 μs) gap across different selected slots.

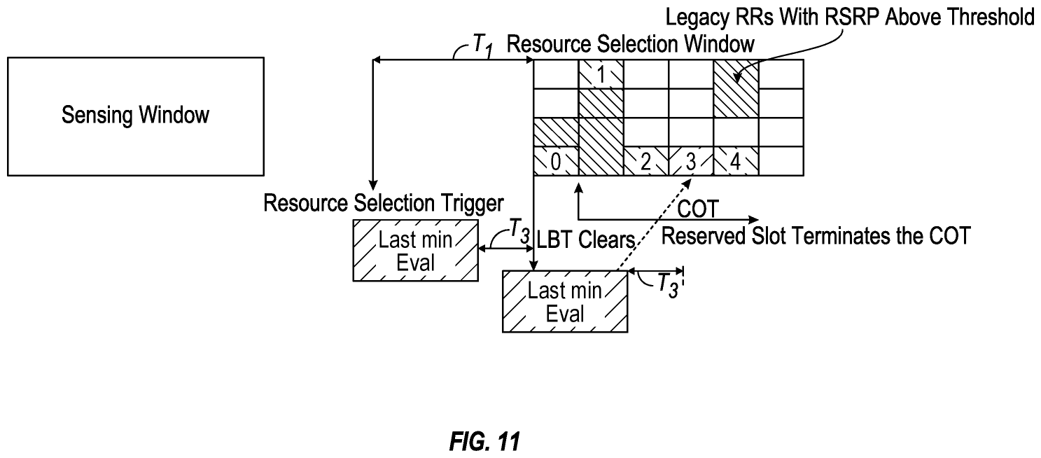

In some cases, a sidelink (or a transmitter) UE may perform an evaluation at a certain time (e.g., T3 time as illustrated in FIG. 11) before a transmission. However, if the transmitter UE has already initiated a COT for multiple TBs transmission, a COT transmission may need to have higher priority for late coming reservations, so that the transmitter UE does not terminate the COT. For example, when the transmitter UE clears an LBT procedure at a first resource and transmits four TBs (e.g., in the first, second, third, and fourth resource), then the evaluation happening after the clearing of the LBT procedure is troubling.

In some cases, a late coming UE (e . . . g, which did not reserve resources) may occupy reserved COT resources with a shorter CPE, to avoid waste of resources, if a reserving UE (e.g., which reserved the resources) cannot check out a COT, and transmission traffic is of a same priority.

In some cases, a transmitter UE may select a CPE for COT resources, based on contention slots. In some cases, different bins of CPE starting points may be associated with a different priority. The transmitter UE may randomly select a starting point within a bin associated with a traffic priority. The late coming UE with a same traffic priority may select the later starting position within the bin (e.g., comparing the reserving UEs).

In some cases, a sidelink design supports eight priority values from ProSe Per-Packet Priority (PPPP) and there may not be enough CPE starting positions for all the priority values. Also, the multiple priority values may be hashed to a same CPE. In such cases, when a subcarrier spacing (SCS) is equal to 30 KHz, there may be upto three CPE positions within one gap symbol.

### Aspects Related to Sidelink Unlicensed (SL-U) Resource Selection for Listen-Before-Talk (LBT) Procedure

Aspects of the present disclosure provide apparatuses, methods, processing systems, and computer-readable mediums for resource selection for multiple listen-before-talk (LBT) opportunities in sidelink unlicensed (SL-U) operations.

As noted above, in SL-U operations, a conventional resource selection method to select a limited number of resources (e.g., for initial and later transmissions) cannot deal with an LBT failure. This is because when there is the LBT failure, additional resources may be needed (e.g., to clear additional LBT procedures and for the initial transmission). In such cases, the LBT failure may trigger a medium access layer (MAC) layer based resource reselection for the additional resources. However, since the MAC layer based resource reselection has a long delay, the additional resources may not be available when needed. In such circumstances, if a transmitter user equipment (UE) determines to use a future resource (e.g., a resource reserved for a retransmission) for the intital transmission, the future reserved resource may also not be available (e.g., since the future reserved resource may be located far out).

Techniques described herein provide improved resource selection for an initial transmission in SL-U operations, by selecting more resources than a number of transport blocks (TBs) for the initial transmission. The improved resource selection allows multiple LBT opportunities to a transmitter UE. The selected resources may be contiguous in time, and multiple TBs for the initial transmission can be transmitted in one channel occupancy time (COT). The techniques described herein may result in a lower latency, since the improved resource selection for the initial transmission in the SL-U operations minimizes transmission delay due to an LBT failure.

In some cases (e.g., for time division multiplex (TDM)ing each subchannel in one LBT subband), a MAC layer of a transmitter UE may indicate a cyclic prefix (CP) extension (CPE) duration in a resource selection for an initial transmission. The techniques described herein further specify how to select the CPE in a presence of CPE reservation, and update the CPE instead of a resource reselection (e.g., during evaluation of a potential resource collision).

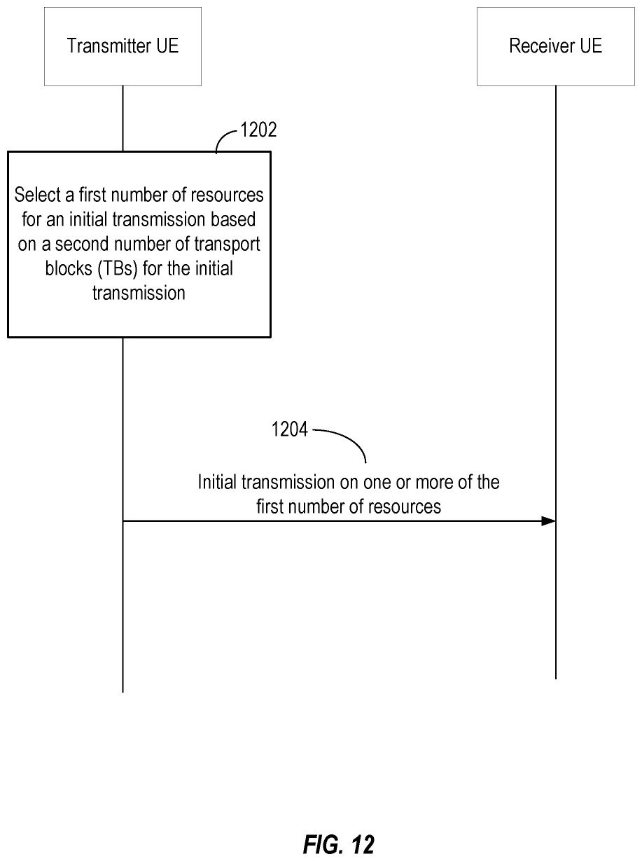

The techniques for the resource selection for the LBT procedure in the SL-U operations proposed herein may be understood with reference to the FIGS. 12-19.

As illustrated in FIG. 12, at 1202, a transmitter UE (e.g., a UE that transmits information to another UE that receives the information) selects a first number (e.g., N2) of resources (e.g., slots) for an initial transmission based on a second number (e.g., N1) of TBs for the initial transmission. The first number is greater than the second number.

At 1204, the transmitter UE transmits the initial transmission on one or more of the first number of resources to a receiver UE (e.g., a sensing UE that receives information transmitted by another UE).

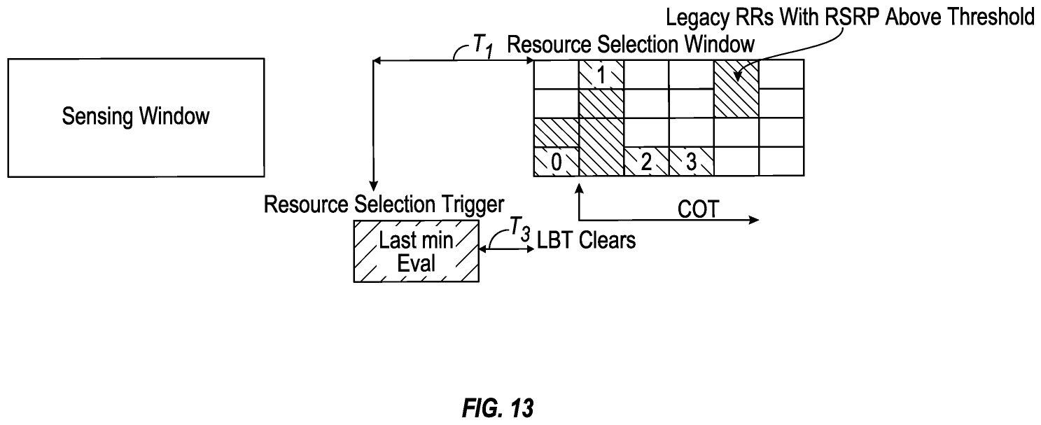

In certain aspects, as illustrated in FIG. 13, the first number of resources are selected in different slots or resource block (RB) sets, and the transmitter UE performs an LBT procedure on the one or more of the first number of resources. For example, the transmitter UE may select more resources in time or in different RB-set than the number of TBs for the initial transmission to allow more opportunities to the transmitter UE for an LBT.

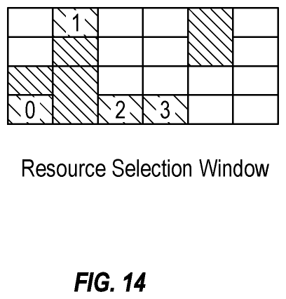

In certain aspects, a MAC layer of the transmitter UE, during a resource selection window (e.g., as illustrated in FIG. 14) for the initial transmission, may overbook resources in time to provide a physical (PHY) layer of the transmitter UE more opportunities to clear the LBT. For example, the MAC layer may select more than one resource in different slots or different RB-sets (e.g., even with 1 terabyte (TB) in a buffer) to provide multiple opportunities for the transmitter UE to clear the LBT. In some cases, when an interference in the different slots or the different RB-set is un-correlated, the PHY layer may have a higher chance to clear the LBT in one of the opportunities. The selected resources (e.g., slots) may not need to be contiguous in time. The transmitter UE may use an earliest opportunity based on time ordering to clear the LBT.

In certain aspects, the transmitter UE performs an LBT procedure across multiple LBT subbands. For example, when multiple frequency domain opportunities are available in a same slot associated with the first number of resources, the transmitter UE may perform the LBT across multiple LBT subbands that may be selected based on a MAC indicated preferred ordering.

In certain aspects, the transmitter UE transmits the second number of TBs on a subset of the first number of resources to occupy the subset of the first number of resources. For example, the transmitter UE may only occupy an adequate amount of resources to transmit TBs in a buffer although more resources may have been selected to to transmit the TBs.

In certain aspects, the transmitter UE performs an LBT procedure using at least one of the first number of resources. The transmitter UE reselects additional resources for the initial transmission after the LBT procedure failure, when available resources within the first number of resources after the LBT procedure for the initial transmission are less than a threshold. For example, due to LBT failures, if remaining resources for LBT attempts are less than a preconfigured threshold and cannot accommodate N1 TBs, then the transmitter UE may trigger a resource reselection instead (e.g., the MAC layer may reselect new resources for remaining TBs).

In certain aspects, the first number of resources are selected to be contiguous in time for transmitting multiple TBs of the second number of TBs in one channel occupancy time (COT). The transmitter UE transmits the multiple TBs of the second number of TBs in the one COT when there is no gap between resources of the first number of resources.

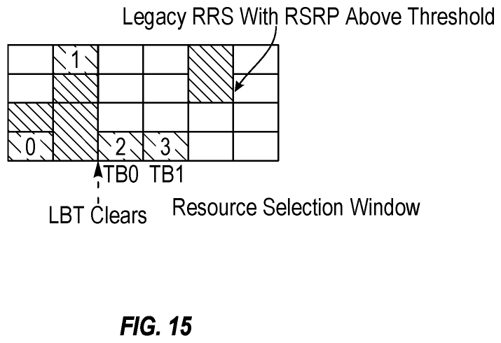

In some cases, a MAC layer may select overbooked contiguous resources in time for multiple TBs and multiple opportunities. For example, as illustrated in FIG. 15, when the transmitter UE has two TBs (e.g., TB0 and TB1) to transmit, the MAC layer may select four contiguous resources in time. In such a case, the transmitter UE transmits the two TBs within one COT when clearing the LBT at ‘0’, ‘1’, or ‘2.’

In certain aspects, the first number of resources are selected to be contiguous from a beginning of a resource selection window (RSW) (e.g., to minimize a transmission delay).

In some cases, the MAC layer may select a different number of subchannels for contiguous slots. The MAC layer may also specify association between the TBs and the selected resources. In some cases, when the MAC layer does not specify the association between the TBs and the selected resources, a PHY layer may not select a resource for each TB and transmit the TBs in a desired ordering based on an LBT result, a TB size and the number of selected subchannel in the slots.

In some cases, when there is overbooking of reserved resources in out-of-COT reservation, there is a need to increase resource utilization when selecting reserved resources. For example, in the out-of-COT reservation, if a certain CPE is reserved, the transmitter UE may overload a same slot or a subchannel with a different CPE.

In certain aspects, the first number of resources are selected based on a CPE. In certain aspects, the transmitter UE may detect an out-of-COT reservation with a certain CPE. In one case, when frequency division multiplexing (FDMing) with the first number of resources, the transmitter UE may select a different subchannel but with the same CPE.

In another case, when TDMing with the first number of resources, the transmitter UE may select a different CPE (e.g., based on a traffic priority). In one example, the different CPE has a first value (e.g., a longer CPE) that is more than a predetermined threshold value when the transmitter UE has a higher priority traffic. In another example, the different CPE has a second value (e.g., a shorter CPE) that is less than the predetermined threshold value when the transmitter UE does not have the higher priority traffic.

In certain aspects, the transmitter UE increases a duration of the CPE (e.g., for second or later LBT opportunities). For example, the transmitter UE may gradually increase the duration of the CPE, based on an opportunity index indicating multiple time-frequency domain opportunities (e.g., indexed in a time order). In some cases, a long CPE may allow the transmitter UE to grab a medium easier. In some cases, the later the position in the selected multiple time-frequency domain opportunities, the more urgent it will for the transmitter UE to clear the LBT.

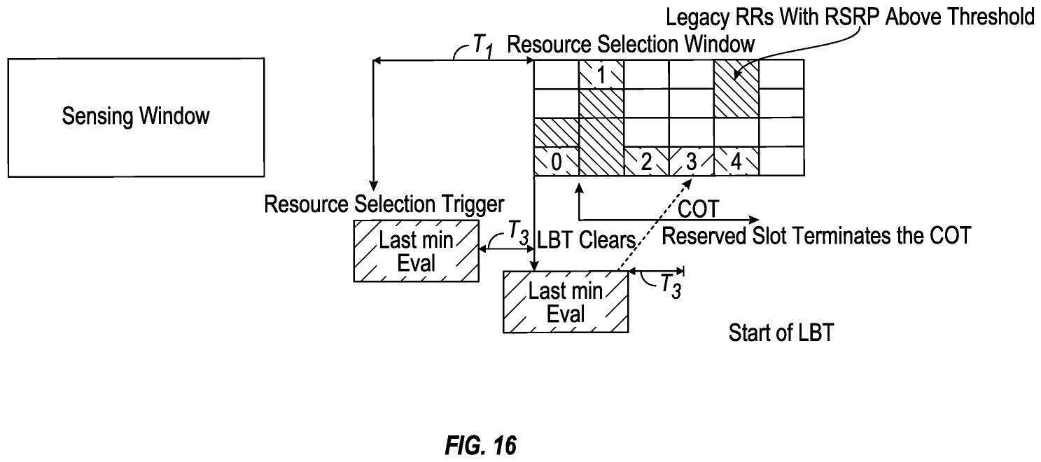

In certain aspects, the transmitter UE performs an evaluation to check for a resource reservation collision in the first number of resources, before transmitting the initial transmission on the one or more of the first number of resources. The transmitter UE detects the resource reservation collision based on the evaluation, and triggers reselection of resources for the initial transmission, based on the detection. For example, as illustrated in FIG. 16, at a resource selection trigger, a MAC layer selects multiple resources in a RSW for an initial transmission. Before performing the initial transmission at the selected resources, a PHY layer performs an evaluation (e.g., at a last minute before the initial transmission) to check for any reservation collision. When the reservation collision is detected, a resource reselection (for new resources for the initial transmission) is triggered.

In certain aspects, the transmitter UE determines whether a COT is initiated for multiple TBs of the second number of TBs transmission. When the COT is initiated for the multiple TBs transmission, a COT transmission has a higher priority than other transmissions. For example, if the transmitter UE has already initiated a COT for multiple TBs transmission, the COT transmission may need to have the higher priority for late coming reservations, so that the transmitter UE does not terminate the COT.

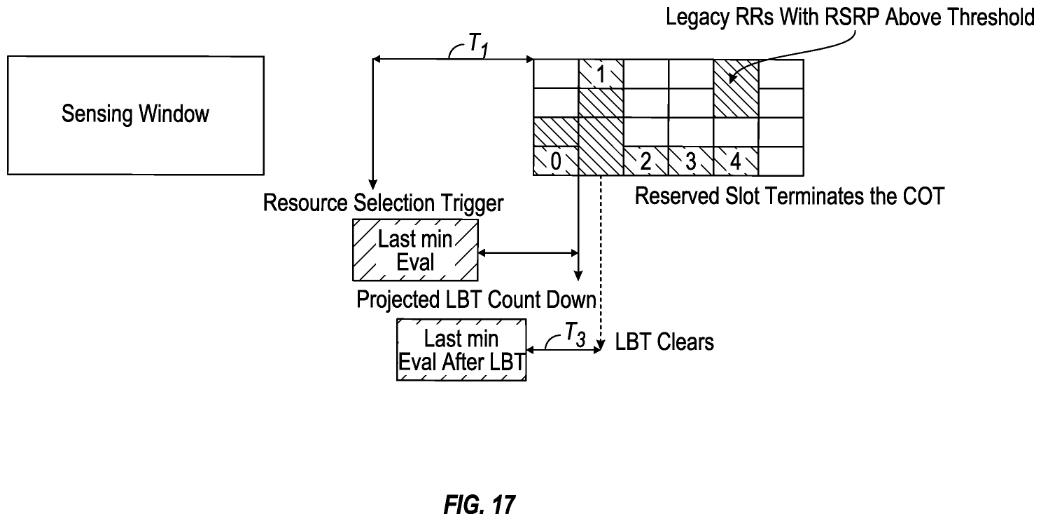

In certain aspects, the transmitter UE performs an evaluation to check for a resource reservation collision, before a first resource of the first number of resources, after performing an LBT procedure. For example, as illustrated in FIG. 17, with multiple selected resources, the transmitter UE may perform the evaluation (e.g., at a last minute after LBT) before the first selected resource after the projected LBT to check for any possible resource collision. In some cases, a MAC layer may project a contention window or get the contention window from a PHY layer, and project the contention window when the PHY layer may finish the LBT countdown.

In certain aspects, the transmitter UE triggers an evaluation of multiple resources of the first number of resources at a same time to check for a resource reservation collision, before performing an LBT procedure. For example, T3 time before the projected LBT countdown time, the MAC layer may trigger the evaluation for the multiple selected resources at once. Additionally, the MAC layer may trigger the evaluation after the LBT clears for the remaining selected resources all at once. In some cases, no additional evaluation may be performed after the LBT as the COT transmission may have a higher priority over the resource reservation.

In certain aspects, the transmitter UE detects the resource reservation collision, based on the evaluation, in one of the first number of resources. In certain aspects, the transmitter UE adjusts a CPE associated with the first number of resources. The CPE is adjusted based on a priority of a traffic. For example, in the evaluation, if the transmitter UE determines a collision in one of selected TDM resources, the CPE is adjusted based on the traffic priority indicated in the colliding reserving SCI. In some cases, in the evaluation, the transmitter UE may detect some reserving SCI-1's that point towards the resources colliding with the MAC selected resources. Moreover, if the colliding reserving SCI indicates the higher traffic priority, the transmitter UE may update the CPE of the colliding resource to be shorter than the CPE indicated in the reserving SCI (e.g., else the original CPE is kept).

In certain aspects, the LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

### Example Operations of a Transmitter UE

FIG. 18 illustrates example operations 1800 for wireless communication. The operations 1800 may be performed, for example, by a transmitter user equipment (UE) (e.g., such as UE 104 in wireless communication network 100 of FIG. 1). The operations 1800 may be implemented as software components that are executed and run on one or more processors (e.g., controller/processor 380 of FIG. 3). Further, transmission and reception of signals by the transmitter UE in the operations 1800 may be enabled, for example, by one or more antennas (e.g., antennas 352 of FIG. 3). In certain aspects, the transmission and/or reception of signals by the transmitter UE may be implemented via a bus interface of one or more processors (e.g., the controller/processor 380) obtaining and/or outputting signals.

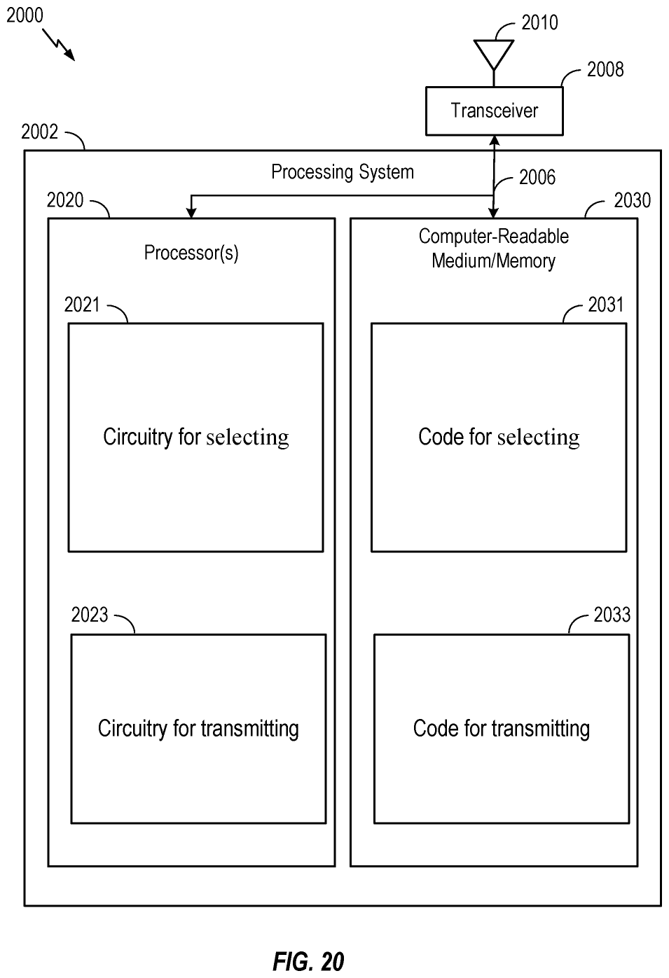

The operations 1800 begin, at 1810, by selecting a first number of resources for an initial transmission based on a second number of transport blocks (TBs) for the initial transmission where the first number is greater than the second number. For example, the transmitter UE may select the first number of resources for the initial transmission, using a processor of UE 104 shown in FIG. 1 or FIG. 3 and/or of the apparatus shown in FIG. 20.

At 1820, the transmitter UE transmits the initial transmission on one or more of the first number of resources. For example, the transmitter UE may transmit the initial transmission on the one or more of the first number of resources, using antenna(s) and/or transmitter/transceiver components of UE 104 shown in FIG. 1 or FIG. 3 and/or of the apparatus shown in FIG. 20.

Note that FIG. 18 is just one example of a method, and other methods including fewer, additional, or alternative steps are possible consistent with this disclosure.

### Example Operations of a Receiver UE

FIG. 19 illustrates example operations 1900 for wireless communication. The operations 1900 may be performed, for example, by a receiver user equipment (UE) (e.g., such as UE 104 in wireless communication network 100 of FIG. 1). The operations 1900 may be implemented as software components that are executed and run on one or more processors (e.g., controller/processor 380 of FIG. 3). Further, transmission and reception of signals by the receiver UE in the operations 1900 may be enabled, for example, by one or more antennas (e.g., antennas 352 of FIG. 3). In certain aspects, the transmission and/or reception of signals by the receiver UE may be implemented via a bus interface of one or more processors (e.g., the controller/processor 380) obtaining and/or outputting signals.

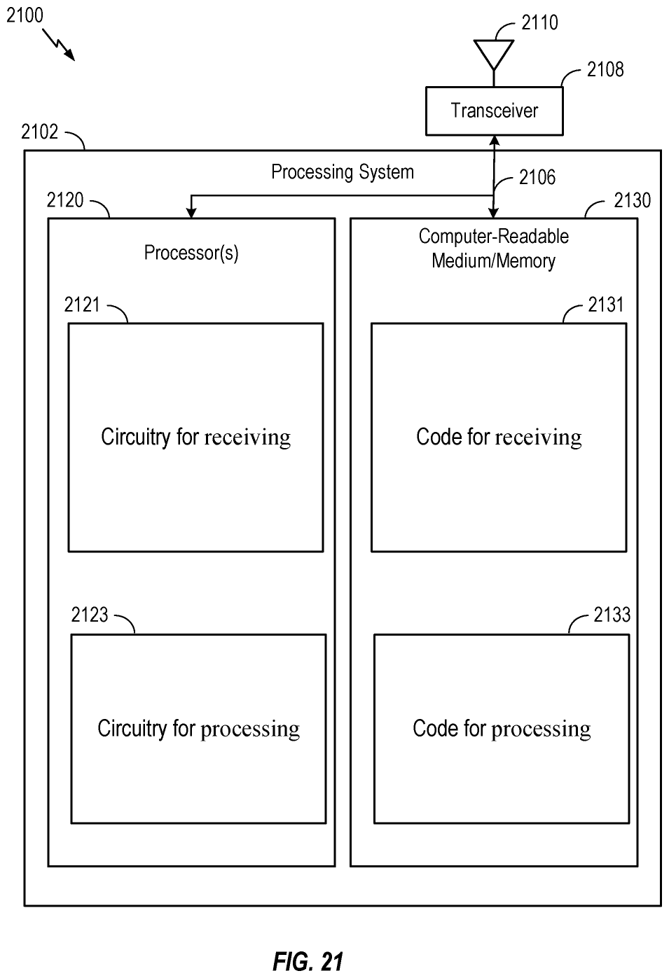

The operations 1900 begin, at 1910, by receiving an initial transmission on one or more of a first number of resources. The first number of resources are selected for the initial transmission based on a second number of transport blocks (TBs) for the initial transmission. The first number is greater than the second number. For example, the receiver UE may receive the initial transmission on the one or more of a first number of resources, using antenna(s) and/or receiver/transceiver components of UE 104 shown in FIG. 1 or FIG. 3 and/or of the apparatus shown in FIG. 21.

At 1920, the receiver UE processes the initial transmission. For example, the receiver UE may process the initial transmission, using a processor of UE 104 shown in FIG. 1 or FIG. 3 and/or of the apparatus shown in FIG. 21.

Note that FIG. 19 is just one example of a method, and other methods including fewer, additional, or alternative steps are possible consistent with this disclosure.

### Example Communications Devices

FIG. 20 depicts aspects of an example communications device 2000. In some aspects, communications device 2000 is a transmitter user equipment (UE), such as UE 104 described above with respect to FIGS. 1 and 3.

The communications device 2000 includes a processing system 2002 coupled to a transceiver 2008 (e.g., a transmitter and/or a receiver). The transceiver 2008 is configured to transmit and receive signals for the communications device 2000 via an antenna 2010, such as the various signals as described herein. The processing system 2002 may be configured to perform processing functions for the communications device 2000, including processing signals received and/or to be transmitted by the communications device 2000.

The processing system 2002 includes one or more processors 2020. In various aspects, the one or more processors 2020 may be representative of one or more of receive processor 358, transmit processor 364, TX MIMO processor 366, and/or controller/processor 380, as described with respect to FIG. 3. The one or more processors 2020 are coupled to a computer-readable medium/memory 2030 via a bus 2006. In certain aspects, the computer-readable medium/memory 2030 is configured to store instructions (e.g., computer-executable code) that when executed by the one or more processors 2020, cause the one or more processors 2020 to perform the operations 1800 described with respect to FIG. 18, or any aspect related to it. Note that reference to a processor performing a function of communications device 2000 may include one or more processors performing that function of communications device 2000.

In the depicted example, computer-readable medium/memory 2030 stores code (e.g., executable instructions) for selecting 2031 comprising code for selecting a first number of resources for an initial transmission based on a second number of transport blocks (TBs) for the initial transmission, the first number is greater than the second number, and code for transmitting 2033 comprising code for transmitting the initial transmission on one or more of the first number of resources. Processing of the code 2031-2033 may cause the communications device 2000 to perform the operations 1800 described with respect to FIG. 18, or any aspect related to it.

The one or more processors 2020 include circuitry configured to implement (e.g., execute) the code stored in the computer-readable medium/memory 2030, including circuitry for selecting 2021 comprising circuitry for selecting a first number of resources for an initial transmission based on a second number of TBs for the initial transmission, the first number is greater than the second number, and circuitry for transmitting 2023 comprising circuitry for transmitting the initial transmission on one or more of the first number of resources. Processing with circuitry 2021-2023 may cause the communications device 2000 to perform the operations 1800 described with respect to FIG. 18, or any aspect related to it.

Various components of the communications device 2000 may provide means for performing the operations 1800 described with respect to FIG. 18, or any aspect related to it. For example, means for transmitting, sending or outputting for transmission may include the transceivers 354 and/or antenna(s) 352 of the UE 104 illustrated in FIG. 3 and/or transceiver 2008 and antenna 2010 of the communications device 2000 in FIG. 20. Means for receiving or obtaining may include the transceivers 354 and/or antenna(s) 352 of the UE 104 illustrated in FIG. 3 and/or transceiver 2008 and antenna 2010 of the communications device 2000 in FIG. 20.

FIG. 21 depicts aspects of an example communications device 2100. In some aspects, communications device 2100 is a receiver UE, such as UE 104 described above with respect to FIGS. 1 and 3.

The communications device 2100 includes a processing system 2102 coupled to a transceiver 2108 (e.g., a transmitter and/or a receiver). The transceiver 2108 is configured to transmit and receive signals for the communications device 2100 via an antenna 2110, such as the various signals as described herein. The processing system 2102 may be configured to perform processing functions for the communications device 2100, including processing signals received and/or to be transmitted by the communications device 2100.

The processing system 2102 includes one or more processors 2120. In various aspects, the one or more processors 2120 may be representative of one or more of receive processor 358, transmit processor 364, TX MIMO processor 366, and/or controller/processor 380, as described with respect to FIG. 3. The one or more processors 2120 are coupled to a computer-readable medium/memory 2130 via a bus 2106. In certain aspects, the computer-readable medium/memory 2130 is configured to store instructions (e.g., computer-executable code) that when executed by the one or more processors 2120, cause the one or more processors 2120 to perform the operations 1900 described with respect to FIG. 19, or any aspect related to it. Note that reference to a processor performing a function of communications device 2100 may include one or more processors performing that function of communications device 2100.

In the depicted example, computer-readable medium/memory 2130 stores code (e.g., executable instructions) for receiving 2131 comprising code for receiving an initial transmission on one or more of a first number of resources where the first number of resources are selected for the initial transmission based on a second number of transport blocks (TBs) for the initial transmission and where the first number is greater than the second number, and code for processing 2133 comprising code for processing the initial transmission. Processing of the code 2131-2133 may cause the communications device 2100 to perform the operations 1900 described with respect to FIG. 19, or any aspect related to it.

The one or more processors 2120 include circuitry configured to implement (e.g., execute) the code stored in the computer-readable medium/memory 2130, including circuitry for receiving 2121 comprising circuitry for receiving an initial transmission on one or more of a first number of resources where the first number of resources are selected for the initial transmission based on a second number of TBs for the initial transmission and where the first number is greater than the second number, and circuitry for processing 2123 comprising circuitry for processing the initial transmission. Processing with circuitry 2121-2123 may cause the communications device 2100 to perform the operations 1900 described with respect to FIG. 19, or any aspect related to it.

Various components of the communications device 2100 may provide means for performing the operations 1900 described with respect to FIG. 19, or any aspect related to it. For example, means for transmitting, sending or outputting for transmission may include the transceivers 354 and/or antenna(s) 352 of the UE 104 illustrated in FIG. 3 and/or transceiver 2108 and antenna 2110 of the communications device 2100 in FIG. 21. Means for receiving or obtaining may include the transceivers 354 and/or antenna(s) 352 of the UE 104 illustrated in FIG. 3 and/or transceiver 2108 and antenna 2110 of the communications device 2100 in FIG. 21.

### Example Clauses

Implementation examples are described in the following numbered clauses:
Clause 1: A method for wireless communications by a transmitter user equipment (UE), comprising: selecting a first number of resources for an initial transmission based on a second number of transport blocks (TBs) for the initial transmission, the first number is greater than the second number; and transmitting the initial transmission on one or more of the first number of resources.
Clause 2: The method alone or in combination with the first clause, wherein the selecting comprises selecting the first number of resources in different slots or resource block (RB) sets; and performing a listen-before-talk (LBT) procedure on the one or more of the first number of resources.
Clause 3: The method alone or in combination with the first clause, further comprising performing a listen-before-talk (LBT) procedure across multiple LBT subbands, when multiple frequency domain opportunities are available in a same slot associated with the first number of resources.
Clause 4: The method alone or in combination with the first clause, further comprising transmitting the second number of TBs on a subset of the first number of resources to occupy the subset of the first number of resources.
Clause 5: The method alone or in combination with the first clause, further comprising: performing a listen-before-talk (LBT) procedure using at least one of the first number of resources; and reselecting additional resources for the initial transmission after the LBT procedure failure, when available resources within the first number of resources after the LBT procedure for the initial transmission are less than a threshold.
Clause 6: The method alone or in combination with the first clause, wherein the selecting comprises selecting the first number of resources that are contiguous in time for transmitting multiple TBs of the second number of TBs in one channel occupancy time (COT).
Clause 7: The method alone or in combination with the sixth clause, wherein the transmitting comprises transmitting the multiple TBs of the second number of TBs in the one COT when there is no gap between resources of the first number of resources.
Clause 8: The method alone or in combination with the first clause, wherein the selecting comprises selecting the first number of resources that are contiguous from a beginning of a resource selection window (RSW).
Clause 9: The method alone or in combination with the first clause, wherein the selecting comprises selecting the first number of resources based on a cyclic prefix (CP) extension (CPE).
Clause 10: The method alone or in combination with the tenth clause, further comprising: detecting an out-of-channel occupancy time (COT) reservation with the CPE; and selecting a different subchannel but with the same CPE, when frequency division multiplexing (FDMing) with the first number of resources.
Clause 11: The method alone or in combination with the ninth cause, further comprising: detecting an out-of-channel occupancy time (COT) reservation with the CPE; and selecting a different CPE, when time division multiplexing (TDMing) with the first number of resources.
Clause 12: The method alone or in combination with the eleventh clause, wherein: the different CPE has a first value that is more than a predetermined threshold value when the transmitter UE has a higher priority traffic; and the different CPE has a second value that is less than the predetermined threshold value when the transmitter UE does not have the higher priority traffic.
Clause 13: The method alone or in combination with the ninth clause, further comprising increasing a duration of the CPE.
Clause 14: The method alone or in combination with the thirteenth clause, wherein the increasing comprises gradually increasing the duration of the CPE, based on an opportunity index indicating multiple time-frequency domain opportunities.
Clause 15: The method alone or in combination with the first clause, further comprising performing an evaluation to check for a resource reservation collision in the first number of resources, before transmitting the initial transmission on the one or more of the first number of resources.
Clause 16: The method alone or in combination with the fifteenth clause, further comprising: detecting the resource reservation collision based on the evaluation; and triggering reselection of resources for the initial transmission, based on the detection.
Clause 17: The method alone or in combination with the first clause, further comprising determining whether a channel occupancy time (COT) is initiated for multiple TBs of the second number of TBs transmission.
Clause 18: The method alone or in combination with the seventeenth clause, wherein when the COT is initiated for the multiple TBs transmission, a COT transmission has a higher priority than other transmissions.
Clause 19: The method alone or in combination with the first clause, further comprising performing an evaluation to check for a resource reservation collision, before a first resource of the first number of resources, after performing a listen-before-talk (LBT) procedure.
Clause 20: The method alone or in combination with the first clause, further comprising triggering an evaluation of multiple resources of the first number of resources at a same time to check for a resource reservation collision, before performing a listen-before-talk (LBT) procedure.
Clause 21: The method alone or in combination with the nineteenth clause, further comprising: detecting the resource reservation collision, based on the evaluation, in one of the first number of resources; and adjusting a cyclic prefix (CP) extension (CPE) associated with the first number of resources.
Clause 22: The method alone or in combination with the twenty-first clause, wherein the adjusting comprises adjusting the CPE based on a priority of a traffic.
Clause 23: A method for wireless communications by a receiver user equipment (UE), comprising: receiving an initial transmission on one or more of a first number of resources, wherein the first number of resources are selected for the initial transmission based on a second number of transport blocks (TBs) for the initial transmission, and wherein the first number is greater than the second number; and processing the initial transmission.
Clause 24: The method alone or in combination with the twenty-third clause, wherein the first number of resources are in different slots or resource block (RB) sets.
Clause 25: The method alone or in combination with the twenty-third clause, wherein the first number of resources are contiguous in time for transmitting multiple TBs of the second number of TBs in one channel occupancy time (COT).
Clause 26: The method alone or in combination with the twenty-third clause, wherein the first number of resources are contiguous from a beginning of a resource selection window (RSW).
Clause 27: An apparatus, comprising: a memory comprising executable instructions; and a processor configured to execute the executable instructions and cause the apparatus to perform a method in accordance with any one of Clauses 1-26.
Clause 28: An apparatus, comprising means for performing a method in accordance with any one of Clauses 1-26.
Clause 29: A non-transitory computer-readable medium comprising executable instructions that, when executed by a processor of an apparatus, cause the apparatus to perform a method in accordance with any one of Clauses 1-26.
Clause 30: A computer program product embodied on a computer-readable storage medium comprising code for performing a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A transmitter user equipment (UE) configured for wireless communications, comprising:
a memory comprising computer-executable instructions; and
a processor configured to execute the computer-executable instructions and cause the transmitter UE to:
select a first number of resources for an initial transmission based on a second number of transport blocks (TBs) for the initial transmission, the first number is greater than the second number; and
transmit the initial transmission on one or more of the first number of resources.

2. The transmitter UE of claim 1, wherein the select comprises select the first number of resources in different slots or resource block (RB) sets; and
the processor is further configured to execute the computer-executable instructions and cause the transmitter UE to: perform a listen-before-talk (LBT) procedure on the one or more of the first number of resources.

3. The transmitter UE of claim 1, wherein the processor is further configured to execute the computer-executable instructions and cause the transmitter UE to: perform a listen-before-talk (LBT) procedure across multiple LBT subbands, when multiple frequency domain opportunities are available in a same slot associated with the first number of resources.

4. The transmitter UE of claim 1, wherein the processor is further configured to execute the computer-executable instructions and cause the transmitter UE to: transmit the second number of TBs on a subset of the first number of resources to occupy the subset of the first number of resources.

5. The transmitter UE of claim 1, wherein the processor is further configured to execute the computer-executable instructions and cause the transmitter UE to:
perform a listen-before-talk (LBT) procedure using at least one of the first number of resources; and
reselect additional resources for the initial transmission after failure of the LBT procedure, when available resources within the first number of resources after the LBT procedure for the initial transmission are less than a threshold.

6. The transmitter UE of claim 1, wherein the select comprises select the first number of resources that are contiguous in time for transmitting multiple TBs of the second number of TBs in one channel occupancy time (COT).

7. The transmitter UE of claim 6, wherein the transmit comprises transmit the multiple TBs of the second number of TBs in the one COT when there is no gap between resources of the first number of resources.

8. The transmitter UE of claim 1, wherein the select comprises select the first number of resources that are contiguous from a beginning of a resource selection window (RSW).

9. The transmitter UE of claim 1, wherein the select comprises select the first number of resources based on a cyclic prefix (CP) extension (CPE).

10. The transmitter UE of claim 9, wherein the processor is further configured to execute the computer-executable instructions and cause the transmitter UE to:
detect an out-of-channel occupancy time (COT) reservation with the CPE; and
select a different subchannel but with the same CPE, when frequency division multiplexing (FDMing) with the first number of resources.

11. The transmitter UE of claim 9, wherein the processor is further configured to execute the computer-executable instructions and cause the transmitter UE to:
detect an out-of-channel occupancy time (COT) reservation with the CPE; and
select a different CPE, when time division multiplexing (TDMing) with the first number of resources.

12. The transmitter UE of claim 11, wherein:
the different CPE has a first value that is more than a predetermined threshold value when the transmitter UE has a higher priority traffic; and
the different CPE has a second value that is less than the predetermined threshold value when the transmitter UE does not have the higher priority traffic.

13. The transmitter UE of claim 9, wherein the processor is further configured to execute the computer-executable instructions and cause the transmitter UE to: increase a duration of the CPE.

14. The transmitter UE of claim 13, wherein the increase comprises gradually increase the duration of the CPE, based on an opportunity index indicating multiple time-frequency domain opportunities.

15. The transmitter UE of claim 1, wherein the processor is further configured to execute the computer-executable instructions and cause the transmitter UE to: perform an evaluation to check for a resource reservation collision in the first number of resources, before transmitting the initial transmission on the one or more of the first number of resources.

16. The transmitter UE of claim 15, wherein the processor is further configured to execute the computer-executable instructions and cause the transmitter UE to:
detect the resource reservation collision based on the evaluation; and
trigger reselection of resources for the initial transmission, based on the detection.

17. The transmitter UE of claim 1, wherein the processor is further configured to execute the computer-executable instructions and cause the transmitter UE to: determine whether a channel occupancy time (COT) is initiated for multiple TBs of the second number of TBs transmission.

18. The transmitter UE of claim 17, wherein when the COT is initiated for the multiple TBs, a COT transmission has a higher priority than other transmissions.

19. The transmitter UE of claim 1, wherein the processor is further configured to execute the computer-executable instructions and cause the transmitter UE to: perform an evaluation to check for a resource reservation collision, before a first resource of the first number of resources, after performing a listen-before-talk (LBT) procedure.

20. The transmitter UE of claim 1, wherein the processor is further configured to execute the computer-executable instructions and cause the transmitter UE to: trigger an evaluation of multiple resources of the first number of resources at a same time to check for a resource reservation collision, before performing a listen-before-talk (LBT) procedure.

21. The transmitter UE of claim 19, wherein the processor is further configured to execute the computer-executable instructions and cause the transmitter UE to:
detect the resource reservation collision, based on the evaluation, in one of the first number of resources; and
adjust a cyclic prefix (CP) extension (CPE) associated with the first number of resources.

22. The transmitter UE of claim 21, wherein the adjust comprises adjust the CPE based on a priority of a traffic.

23. A receiver user equipment (UE) configured for wireless communications, comprising:
a memory comprising computer-executable instructions; and
a processor configured to execute the computer-executable instructions and cause the receiver UE to:
receive an initial transmission on one or more of a first number of resources, wherein the first number of resources are selected for the initial transmission based on a second number of transport blocks (TBs) for the initial transmission, and wherein the first number is greater than the second number; and
process the initial transmission.

24. The receiver UE of claim 23, wherein the first number of resources are in different slots or resource block (RB) sets.

25. The receiver UE of claim 23, wherein the first number of resources are contiguous in time for transmitting multiple TBs of the second number of TBs in one channel occupancy time (COT).

26. The receiver UE of claim 23, wherein the first number of resources are contiguous from a beginning of a resource selection window (RSW).

27. A method for wireless communications by a transmitter user equipment (UE), comprising:
selecting a first number of resources for an initial transmission based on a second number of transport blocks (TBs) for the initial transmission, the first number is greater than the second number; and
transmitting the initial transmission on one or more of the first number of resources.

28. The method of claim 27, wherein the selecting comprises selecting the first number of resources in different slots or resource block (RB) sets; and
performing a listen-before-talk (LBT) procedure on the one or more of the first number of resources.

29. A method for wireless communications by a receiver user equipment (UE), comprising:
receiving an initial transmission on one or more of a first number of resources, wherein the first number of resources are selected for the initial transmission based on a second number of transport blocks (TBs) for the initial transmission, and wherein the first number is greater than the second number; and
processing the initial transmission.

30. The method of claim 29, wherein the first number of resources are in different slots or resource block (RB) sets.
